(19) United States
(12) Patent Application Publication
(10) Pub. No.: US 2013/0137487 A1
(43) Pub. Date: May 30, 2013

(54) PORTABLE INFORMATION TERMINAL

(71) Applicant: Koichi Sato, Tachikawa-shi (JP)

(72) Inventor: Koichi Sato, Tachikawa-shi (JP)

(21) Appl. No.: 13/546,706

(22) Filed: Jul. 11, 2012

(30) Foreign Application Priority Data
Nov. 30, 2011 (JP) 2011-262864

(51) Int. Cl. H04W 52/38

(52) U.S. Cl. 455/566

(57) ABSTRACT

According to one embodiment, a portable information terminal includes a housing, on a surface portion of which a display unit is arranged, an antenna unit which is arranged to extend from a side surface portion to a back surface portion of this housing, a first sensor configured to detect an orientation of the housing, and a controller. When this controller determines based on the detection result of the first sensor that the orientation of the housing corresponds to a horizontal state or nearly horizontal state within predetermined angle range, it suppresses a transmission power of the antenna unit.

### CROSS-REFERENCE TO RELATED APPLICATIONS

This application is based upon and claims the benefit of priority from prior Japanese Patent Application No. 2011-262864, filed Nov. 30, 2011, the entire contents of which are incorporated herein by reference.

### FIELD

Embodiments described herein relate generally to a portable information terminal including an antenna used to radiate radio waves.

### BACKGROUND

In recent years, as portable information terminals, a tablet type terminal which adopts a tablet as a display unit, and a notebook type personal computer in which a display unit having a tablet is pivotally attached to a main body via hinges have prevailed. A terminal of this type includes a radio module and antenna, and can download contents and various data from Web sites and the like using them.

When the terminal of this type is used, the antenna often comes near the body (abdomen, chest, arm, or the like) of the user. In USA specifies an upper limit value of an SAR (Specific Absorption Rate) as a physical quantity that represents a degree of energy of electromagnetic waves absorbed by the human body, and it is an obligation to observe these regulations.

Hence, a technique for lowering a transmission power when proximity to a user is detected by a sensor, which is arranged in a terminal to detect proximity to the user, and a technique for switching, when a terminal is located to set one of a plurality of antennas, which are arranged on different sides of a housing, in a direction to approach the user, that antenna to another antenna have been proposed (for example, see U.S. Patent Application Publication No. 2009/0305742 or Jpn. Pat. Appln. KOKAI Publication No. 2007-295393).

However, the techniques described in these literatures have been developed under the assumption that an antenna is arranged on a side surface portion of a housing. However, the antenna is often arranged not only on the side surface of the housing but also on the back surface, that is, a surface opposite to the surface on which the tablet type display unit is arranged. In such case, the influence of radio waves radiated from the antenna on the user is not taken into consideration.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a perspective view showing the outer appearance of a portable information terminal according to the first embodiment;

FIG. 2 is a functional block diagram of the portable information terminal shown in FIG. 1;

FIG. 3 is a circuit diagram showing the arrangement of an antenna of the portable information terminal shown in FIG. 2;

FIGS. 4A, 4B, and 4C are views showing different use states of the portable information terminal shown in FIG. 1;

FIG. 5 is a perspective view showing the outer appearance of a portable information terminal according to the second embodiment;

FIG. 6 is a functional block diagram of the portable information terminal shown in FIG. 5;

FIG. 7 is a functional block diagram showing the circuit arrangement of a portable information terminal according to the third embodiment;

FIG. 8 is a circuit diagram showing the arrangement of an antenna of the portable information terminal shown in FIG. 7;

FIG. 9 is a functional block diagram of a portable information terminal according to the fourth embodiment;

FIG. 10 is a circuit diagram showing the arrangement of an antenna of the portable information terminal shown in FIG. 9;

FIG. 11 is a functional block diagram of a portable information terminal according to the fifth embodiment;

FIG. 12 is a circuit diagram showing the arrangement of an antenna of a portable information terminal according to the sixth embodiment; and

FIG. 13 is a circuit diagram showing the arrangement of an antenna of a portable information terminal according to the seventh embodiment.

### DETAILED DESCRIPTION

Various embodiments will be described hereinafter with reference to the accompanying drawings.

In general, according to one embodiment, a portable information terminal includes a housing, on a surface portion of which a display unit is arranged, an antenna unit which is arranged to extend from a side surface portion to a back surface portion of this housing, a first sensor configured to detect an orientation of the housing, and a controller. When this controller determines based on the detection result of the first sensor that the orientation of the housing corresponds to a horizontal state or nearly horizontal state within a predetermined angle range, it suppresses a transmission power of the antenna unit.

### First Embodiment

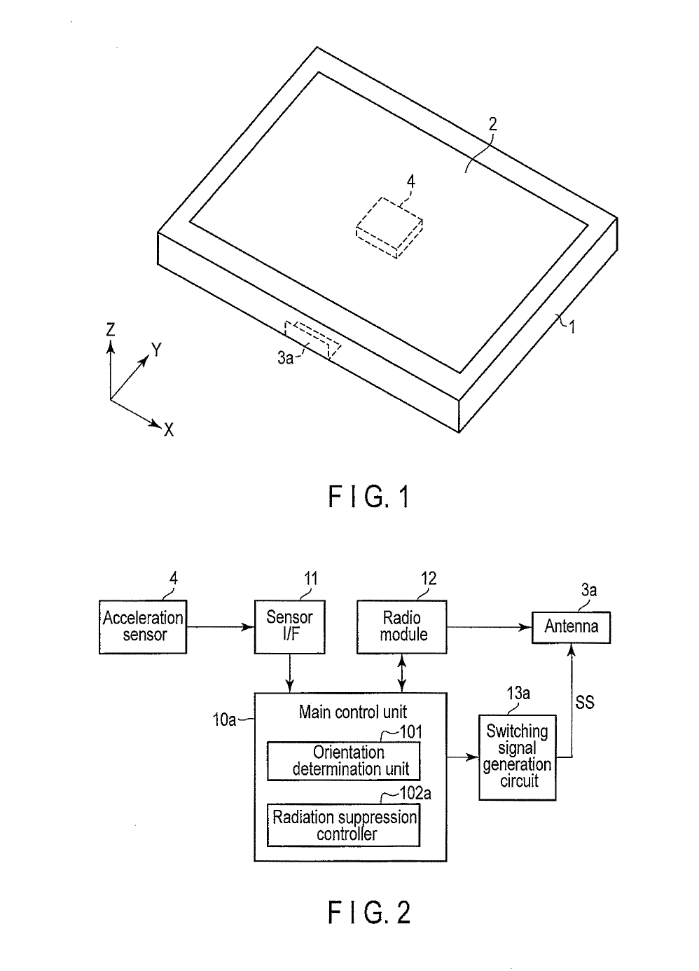

FIG. 1 is a perspective view showing the outer appearance of a portable information terminal according to the first embodiment.

This portable information terminal is a tablet type terminal, and a tablet type display unit 2 is arranged on one surface (to be referred to as an upper surface hereinafter) of a plate-shaped housing 1. This tablet type display unit 2 is prepared by, for example, arranging an electrostatic sheet used to detect a touch operation of the user on the display surface of a liquid crystal display or organic EL display.

On one side of the housing 1, an antenna 3a is arranged to extend from its side surface to a lower surface (to be also referred to as a back surface or bottom surface hereinafter). The antenna 3a is prepared by, for example, forming a conductive pattern which forms a folded type antenna element on a printed circuit board or an inner surface of the housing 1, and transmits/receives a radio signal used in a mobile communication network that adopts the 3G/LTE standards, a wireless Local Area Network (LAN), WiMAX®, Ultra Wideband (UWB), Bluetooth®, or the like.

Furthermore, an orientation sensor 4 is arranged at, for example, the central portion of the bottom surface in the housing 1. This orientation sensor 4 includes an acceleration sensor, and detects an acceleration externally applied to the housing 1 respectively in three axial directions, x, y, and z in space.

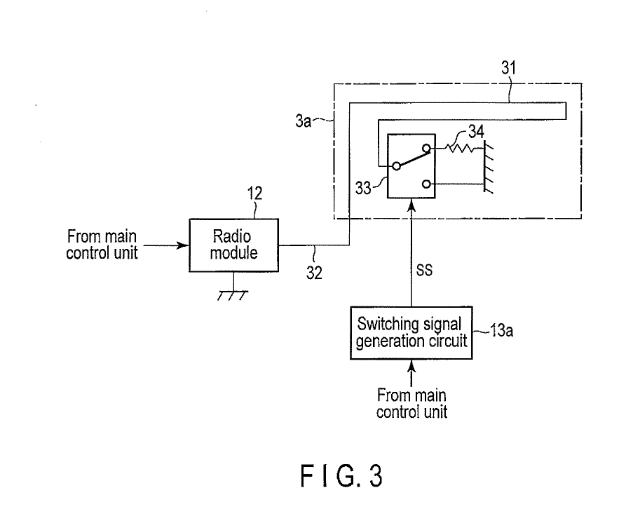

FIG. 2 is a functional block diagram of the portable information terminal according to the first embodiment, and FIG. 3 is a circuit diagram of the antenna 3a.

The portable information terminal includes, as circuit units, a main control unit 10a, sensor interface (sensor I/F) 11, radio module 12, and switching signal generation circuit 13a.

The sensor I/F 11 converts a detection signal from the orientation sensor (to be also referred to as an acceleration sensor hereinafter) 4 into a digital signal, and inputs the digital signal to the main control unit 10a. The radio module 12 has a baseband processor and frequency converter. The baseband processor executes encoding/decoding processing, modulation/demodulation processing, and the like of transmission/reception data. The frequency converter frequency-converts a transmission baseband signal which has undergone the encoding and modulation processes into a radio signal corresponding to a radio channel, and frequency-converts a received radio signal into a reception baseband signal. To this frequency converter, the antenna 3a is connected via a feeder cable 32.

The main control unit 10a has, for example, a microcomputer, and has an orientation determination unit 101 and radiation suppression controller 102a as control functions required to implement the first embodiment. Both of the orientation determination unit 101 and radiation suppression controller 102a are implemented when a CPU (Central Processing Unit) executes programs.

The orientation determination unit 101 fetches digital data of triaxial acceleration detected by the acceleration sensor 4 from the sensor I/F 11, and executes processing for determining based on the fetched data whether or not an orientation of the housing 1 corresponds to a horizontal state or nearly horizontal state within a predetermined tilt angle range.

The radiation suppression controller 102a has a function of supplying, to the switching signal generation circuit 13a, a switching control instruction required to suppress a transmission power of a radio signal transmitted from the antenna 3a when the orientation determination unit 101 determines that the orientation of the housing 1 corresponds to the horizontal state or nearly horizontal state during a radio transmission period.

The switching signal generation circuit 13a has a function of generating a switching signal SS required to switch whether or not to connect a resistor 34 (to be described later) in accordance with the switching control instruction, and supplying this switching signal SS to the antenna 3a.

As shown in, for example, FIG. 3, the folded monopole antenna 3a includes the resistor 34 and a switch 33. One end portion of the antenna element 31 is connected to the radio module 12 via the feeder cable 32. The switch 33 operates according to the switching signal SS output from the switching signal generation circuit 13a. The switch 33 switches between a state in which the other end portion of the antenna element 31 is connected to ground via the resistor 34 and a state in which the other end portion of the antenna element 31 is connected to ground.

The operation of the portable information terminal with the aforementioned arrangement will be described below.

In the main control unit 10a, during the operation of the terminal, the orientation determination unit 101 fetches digital data of triaxial acceleration detected by the acceleration sensor 4 via the sensor I/F 11, and monitors the orientation of the housing 1 based on the fetched data.

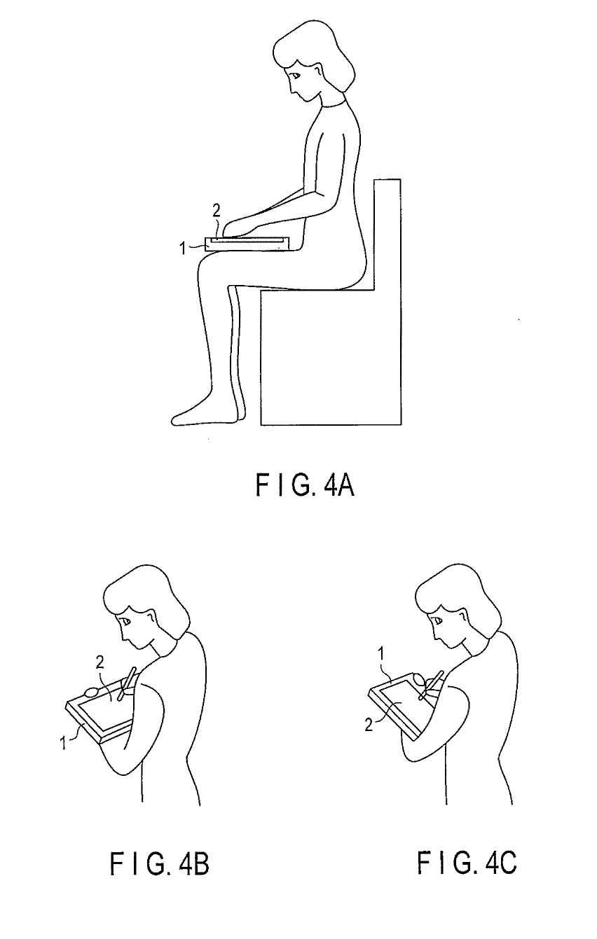

In this state, assume that the user operates the terminal on the knees, as shown in, for example, FIG. 4A or while holding it, as shown in FIG. 4B or 4C. In these states, the orientation of the terminal corresponds to a horizontal state or nearly horizontal state. This horizontal state or nearly horizontal state is detected by the orientation determination unit 101.

When that state is detected, the radiation suppression controller 102a executes radiation suppression control of a radio signal as follows. That is, whether or not a radio signal is being transmitted is determined. If the radio signal is being transmitted, a switching control instruction required to suppress a transmission power of the radio signal to be transmitted from the antenna 3a is supplied to the switching signal generation circuit 13a. Upon reception of this switching control instruction, the switching signal generation circuit 13a outputs the switching signal SS. In response to this switching signal SS, the switch 33 is switched from the ground side to the resistor 34 side, as shown in FIG. 3. As a result, when a current of the antenna element 31 flows through the resistor 34, it is turned into a heat energy by this resistor 34, and the antenna gain 31 in both the side surface and bottom surface directions of the housing 1 are consequently suppressed.

As described in detail above, according to the first embodiment, whether or not the orientation of the housing 1 corresponds to a horizontal state or nearly horizontal state is determined based on digital data of triaxial acceleration detected by the acceleration sensor 4. When it is determined during a radio transmission period that the orientation of the housing 1 corresponds to the horizontal state or nearly horizontal state, the switching signal SS is supplied to the switch 33 of the antenna 3a via the switching signal generation circuit 13a, thereby connecting the antenna element 31 to the ground via the resistor 34.

Therefore, when a current of the antenna element 31 flows through the resistor 34, it is turned into a heat energy by the resistor 34, and the antenna gain in both the side surface and bottom surface directions of the housing 1 are consequently suppressed. For this reason, even when the side surface portion and bottom surface portion where the antenna 3a is arranged of the housing 1 contact or are close to the user, as shown in, for example, FIGS. 4A, 4B, and 4C, the influence of transmission radio waves on the user can be suppressed.

### Second Embodiment

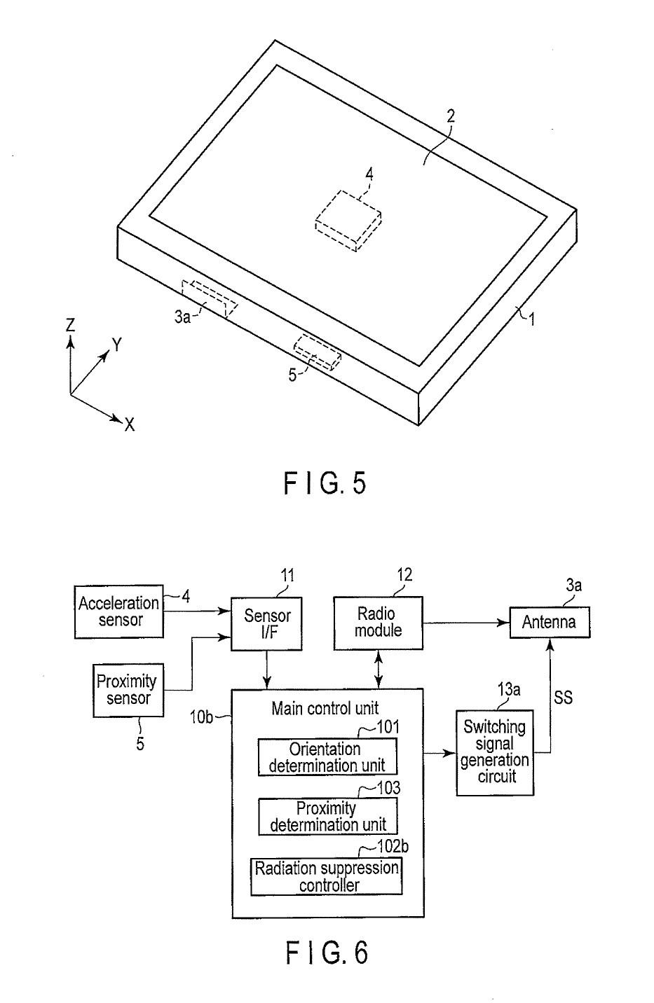

FIG. 5 is a perspective view showing the outer appearance of a portable information terminal according to the second embodiment. Note that the same reference numerals in FIG. 5 denote the same parts as in FIG. 1, and a detailed description thereof will not be repeated.

On a bottom portion in the vicinity of the same side as that where an antenna 3a is arranged in a housing 1, a proximity sensor 5 is arranged. The proximity sensor 5 includes, for example, a capacitance sensor, and detects the proximity of a human body in the side surface and lower surface directions of the side where the antenna 3a is arranged of the housing 1.

FIG. 6 is a functional block diagram of the portable information terminal according to the second embodiment. Note that the same reference numerals in FIG. 6 denote the same parts as in FIG. 2, and a detailed description thereof will not be repeated. Also, the arrangement of the antenna 3a is the same as that shown in FIG. 3, and a description thereof will not be repeated.

A proximity detection signal output from the proximity sensor 5 is converted into digital data by a sensor I/F 11 together with an acceleration detection signal output from acceleration sensor 4, and these digital data are then fetched by a main control unit 10b.

The main control unit 10b includes an orientation determination unit 101, proximity determination unit 103, and radiation suppression controller 102b as control functions required to implement this second embodiment. Of these units, the proximity determination unit 103 fetches digital data of the proximity detection signal output from the proximity sensor 5 from the sensor I/F 11. Based on this fetched data, the proximity determination unit 103 executes processing for determining whether or not a human body gets close to the side surface portion or bottom surface portion of the side where the antenna 3a is arranged of the housing 1 so as to fall within a predetermined distance range.

During a radio transmission period, when the orientation determination unit 101 determines that the orientation of the housing 1 corresponds to a horizontal state or nearly horizontal state, and the proximity determination unit 103 determines that a human body gets close to the side surface portion or bottom surface portion of the side where the antenna 3a is arranged of the housing 1 to fall within a predetermined distance range, the radiation suppression controller 102b supplies a switching control instruction required to suppress a transmission power of a radio signal to be transmitted from the antenna 3a to a switching signal generation circuit 13a.

With this arrangement, the orientation determination unit 101 of the main control unit 10b fetches digital data of triaxial acceleration detected by the acceleration sensor 4 from the sensor I/F 11, and monitors the orientation of the housing 1 based on this data during the operation of the terminal. At the same time, the main control unit 10b fetches digital data of a proximity detection signal output from the proximity sensor 5 from the sensor I/F 11, and monitors, based on this data, the proximity of a human body to one or both of the side surface portion and bottom surface portion of the side is monitored where the antenna 3a is arranged of the housing 1.

In this state, assume that the user operates the terminal on the knees, as shown in, for example, FIG. 4A or while holding it, as shown in FIG. 4B or 4C. In these states, the orientation of the terminal corresponds to a horizontal state or nearly horizontal state. This horizontal state or nearly horizontal state is detected by the orientation determination unit 101. Also, in any of the aforementioned states, the user contacts or gets close to one or both of the side surface portion and bottom surface portion of the side where the antenna 3a is arranged of the housing 1 within a predetermined distance range. This state is detected by the proximity determination unit 103.

When the horizontal or nearly horizontal state is detected, and the state in which the user contacts or gets close to one or both of the side surface portion and bottom surface portion of the side where the antenna 3a is arranged of the housing 1 within a predetermined distance range is detected, the radiation suppression controller 102b generates a switching control instruction required to suppress a transmission power of a radio signal transmitted from the antenna 3a during a radio signal transmission period, and supplies that control instruction to the switching signal generation circuit 13a. Upon reception of this switching control instruction, the switching signal generation circuit 13a outputs a switching signal SS. In response to this switching signal SS, a switch 33 is switched from the ground side to the resistor 34 side, as shown in FIG. 3. For this reason, when a current of the antenna element 31 flows through the resistor 34, it is turned into a heat energy by this resistor 34, and the strengths of radio waves of radio signals radiated from an antenna element 31 in both the side surface and bottom surface directions of the housing 1 are consequently suppressed.

As described in detail above, according to the second embodiment, whether or not the orientation of the housing 1 corresponds to a horizontal state or nearly horizontal state is determined based on the detection signal from the acceleration sensor 4. At the same time, whether or not the user contacts or gets close to one or both of the side surface portion and bottom surface portion of the side where the antenna 3a is arranged of the housing 1 within a predetermined distance range is determined based on the detection signal from the proximity sensor 5. Then, when it is determined that the orientation of the housing 1 corresponds to a horizontal state or nearly horizontal state and also that the user contacts or gets close to one or both of the side surface portion and bottom surface portion of the side where the antenna 3a is arranged of the housing 1 within a predetermined distance range, the switching signal SS is supplied to the switch 33 of the antenna 3a via the switching signal generation circuit 13a, thereby connecting the antenna element 31 to ground via the resistor 34.

Therefore, when a current of the antenna element 31 flows through the resistor 34, it is turned into a heat energy by this resistor 34, and the antenna gain 31 in both the side surface and bottom surface directions of the housing 1 are consequently suppressed. For this reason, even when the side surface portion and bottom surface portion where the antenna 3a is arranged of the housing 1 contacts or is close to the user, as shown in, for example, FIGS. 4A, 4B, and 4C, the influence of transmission radio waves on the user can be suppressed.

The transmission radio wave strength is controlled in consideration of the determination result as to whether or not the user contacts or gets close to one or both of the side surface portion and bottom surface portion of the side where the antenna 3a is arranged of the housing 1 within a predetermined distance range in addition to the determination result as to whether or not the orientation of the housing 1 corresponds to a horizontal state or nearly horizontal state. For this reason, when the user operates the terminal while horizontally placing it on a table or bag, it is determined that the influence of transmission radio waves on the user is small, and the transmission radio wave strength is not suppressed. Therefore, a radio signal can be transmitted to have a sufficiently high strength.

Furthermore, since the proximity sensor 5 is arranged on the same side as that where the antenna 3c is arranged of the housing 1, the following advantage can be provided. That is, one proximity sensor 5 can detect the proximity of the user to the bottom surface of the housing 1 and that of the user to the side where the antenna 3c is arranged of the housing 1.

### Third Embodiment

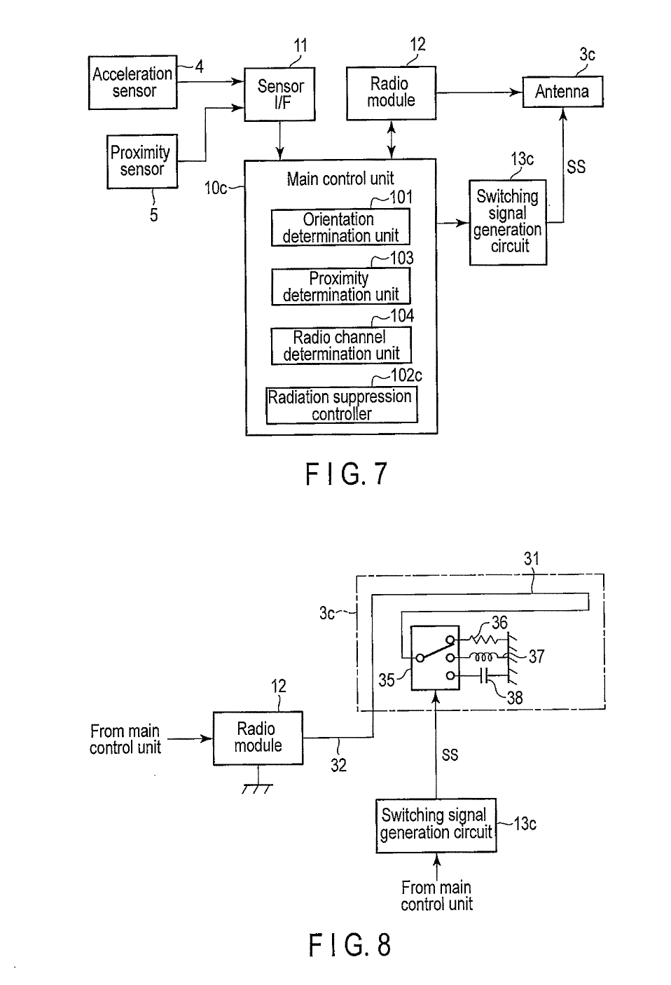

FIG. 7 is a functional block diagram of a portable information terminal according to the third embodiment, and FIG. 8 is a circuit diagram of an antenna 3c. Note that the same reference numerals in FIGS. 7 and 8 denote the same parts as those in FIGS. 2, 3, and 6, and a detailed description thereof will not be repeated.

A main control unit 10c includes an orientation determination unit 101, proximity determination unit 103, radio channel determination unit 104, and radiation suppression controller 102c as control functions required to implement this third embodiment.

The radio channel determination unit 104 has a function of determining a frequency channel of a radio signal transmitted from a radio module 12.

The radiation suppression controller 102c has a function of supplying a switching control instruction required to reduce the matching characteristics of the antenna 3c with respect to a radio transmission channel according to the radio transmission channel determined by the radio channel determination unit 104 to a switching signal generation circuit 13c during a radio transmission period, when the orientation determination unit 101 determines that the orientation of the housing 1 corresponds to a horizontal state or nearly horizontal state, and the proximity determination unit 103 determines that a human body is close to the side surface portion or bottom surface portion of a side where the antenna 3c is arranged of the terminal housing 1 within a predetermined distance range.

The switching signal generation circuit 13c has a function of generating a switching signal SS required to switch a type of a lumped parameter element (to be described later) according to the switching control instruction, and supplying this switching signal SS to the antenna 3c.

As shown in FIG. 8, the antenna 3c includes an antenna element 31 formed by folding a monopole element at its middle position, a lumped parameter element which decides the matching characteristics of the antenna element 31 and includes a resistor 36, inductor 37, and capacitor 38, and a switch 35. The switch 35 operates according to the switching signal SS output from the switching signal generation circuit 13c. The switch 35 connects one of the resistor 36, inductor 37, and capacitor 38 between the other end portion of the antenna element 31 and ground.

With this arrangement, assume that a horizontal state or nearly horizontal state of the housing 1 of the terminal is detected, and a state in which the user contacts or gets close to one or both of the side surface portion and bottom surface portion of the side where the antenna 3c is arranged of the housing 1 within a predetermined distance range is detected, as described in the second embodiment. Then, the radiation suppression controller 102c generates a switching control instruction required to reduce the matching characteristics of the antenna 3c with respect to a radio transmission channel in accordance with the radio transmission channel determined by the radio channel determination unit 104, and supplies that instruction to the switching signal generation circuit 13c.

As a result, the switching signal generation circuit 13c supplies the switching signal SS required to switch the lumped parameter element to the switch 35, thereby switching the lumped parameter element connected to the antenna element 31 to one of the resistor 36, inductor 37, and capacitor 38. Therefore, the matching characteristics of the antenna element 31 with respect to the radio transmission channel, for example, VSWR (Voltage-Standing Wave Ratio) frequency characteristics change, thus consequently suppressing a transmission power by the radio transmission channel.

As described in detail above, according to the third embodiment, during a radio transmission period, when it is determined that the orientation of the housing 1 of the terminal corresponds to a horizontal state or nearly horizontal state, and it is determined that the user contacts or gets close to one or both of the side surface portion and bottom surface portion of the side where the antenna 3c is arranged of the housing 1 within a predetermined distance range, the radio channel determination unit 104 determines a channel used in the radio transmission. Then, the switching signal SS is supplied to the switch 35 of the antenna 3c via the switching signal generation circuit 13c according to that determination result, thereby switching the lumped parameter element which specifies the matching characteristics of the antenna element 31 with respect to the radio transmission channel.

Therefore, the matching characteristics of the antenna 3c with respect to the radio channel used in transmission are reduced, thus suppressing a transmission power by that radio transmission channel. As a result, even when the side surface portion and bottom surface portion where the antenna 3c is arranged of the housing 1 contacts or is close to the user, as shown in, for example, FIGS. 4A, 4B, and 4C, the influence of transmission radio waves on the user can be suppressed. The lumped parameter element is originally set to attain optimal matching characteristics of the antenna element 31, and the matching characteristics of the antenna element 31 are reduced by changing this lumped parameter element on purpose. For this reason, a transmission power can be suppressed without modifying a transmission power control system of the radio module 12.

### Fourth Embodiment

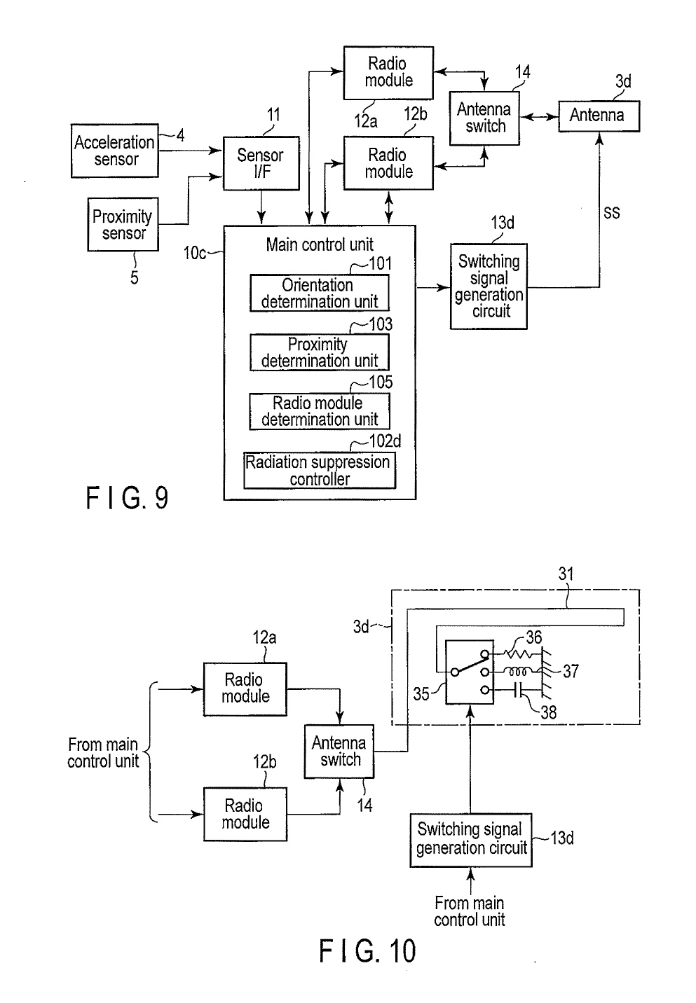

FIG. 9 is a functional block diagram of a portable information terminal according to the fourth embodiment, and FIG. 10 is a circuit diagram showing the arrangement of an antenna 3d and its peripheral units. Note that the same reference numerals in FIGS. 9 and 10 denote the same parts as those in FIGS. 7 and 8, and a detailed description thereof will not be repeated.

The portable information terminal according to the fourth embodiment includes two radio modules 12a and 12b. These radio modules 12a and 12b are compatible with different wireless systems (for example, a wireless LAN (Wi-Fi®) and WiMAX®), and are selectively connected to the antenna 3d by an antenna switch 14.

A main control unit 10d includes an orientation determination unit 101, proximity determination unit 103, radio module determination unit 105, and radiation suppression controller 102d as control functions required to implement this fourth embodiment.

The radio module determination unit 105 has a function of determining, based on the switching state of the antenna switch 14, which one of the radio modules 12a and 12b is in use, that is, which radio module is connected to the antenna 3d.

The radiation suppression controller 102d has a function of supplying a switching control instruction required to reduce the matching characteristics of the antenna 3d with respect to a radio frequency band used by the radio module according to the radio module 12a or 12b in use determined by the radio module determination unit 105 to a switching signal generation circuit 13d during a radio transmission period, when the orientation determination unit 101 determines that the orientation of the housing 1 corresponds to a horizontal state or nearly horizontal state, and the proximity determination unit 103 determines that a human body is close to the side surface portion or bottom surface portion of a side where the antenna 3d is arranged of the housing 1 within a predetermined distance range.

With this arrangement, assume that a horizontal state or nearly horizontal state of the housing 1 of the terminal is detected, and a state in which the user contacts or gets close to one or both of the side surface portion and bottom surface portion of the side where the antenna 3d is arranged of the housing 1 within a predetermined distance range is detected, as described in the second embodiment. Then, the radiation suppression controller 102d generates a switching control instruction required to reduce the matching characteristics of the antenna 3d with respect to a radio frequency band used by the radio module 12a or 12b in accordance with the radio module 12a or 12b in use determined by the radio module determination unit 105, and supplies that instruction to the switching signal generation circuit 13d.

As a result, as in the third embodiment, the switching signal generation circuit 13d outputs a switching signal SS required to switch a lumped parameter element, and supplies that signal to the switch 35, thereby switching the lumped parameter element connected to an antenna element 31 to one of a resistor 36, inductor 37, and capacitor 38. Therefore, the matching characteristics of the antenna element 31 with respect to the radio frequency band used in transmission by the radio module 12a or 12b in use, for example, VSWR (Voltage-Standing Wave Ratio) frequency characteristics change, thus consequently suppressing a transmission power of the radio frequency band.

As described in detail above, according to the fourth embodiment, during a radio transmission period, when it is determined that the orientation of the housing 1 of the terminal corresponds to a horizontal state or nearly horizontal state, and it is determined that the user contacts or gets close to one or both of the side surface portion and bottom surface portion of the side where the antenna 3d is arranged of the housing 1 within a predetermined distance range, the radio module determination unit 105 determines the radio module in use. Then, the switching signal SS is supplied to the switch 35 of the antenna 3d via the switching signal generation circuit 13d according to that determination result, thereby switching the lumped parameter element which specifies the matching characteristics of the antenna element 31 with respect to the radio frequency band used by the radio module which is currently used in radio transmission.

Therefore, the matching characteristics of the antenna 3d with respect to the radio frequency band used in transmission by the radio module 12a or 12b are reduced, thus suppressing a transmission power in that radio frequency band. As a result, even when the side surface portion and bottom surface portion where the antenna 3d is arranged of the housing 1 contacts or is close to the user, as shown in, for example, FIGS. 4A, 4B, and 4C, the influence of transmission radio waves on the user can be suppressed. The lumped parameter element is originally set to attain optimal matching characteristics of the antenna element 31, and the matching characteristics of the antenna element 31 are reduced by changing this lumped parameter element on purpose. For this reason, a transmission power can be suppressed without modifying a transmission power control system of the radio module 12.

### Fifth Embodiment

In the third and fourth embodiments, the type of the lumped parameter element is switched using the switch 35. For example, a variable resistor, variable inductor, or variable capacitance type capacitor may be used as the lumped parameter element, and the value of each of these elements may be variably controlled. Then, the switching signal generation circuit 13c or 13d and switch 35 can be omitted.

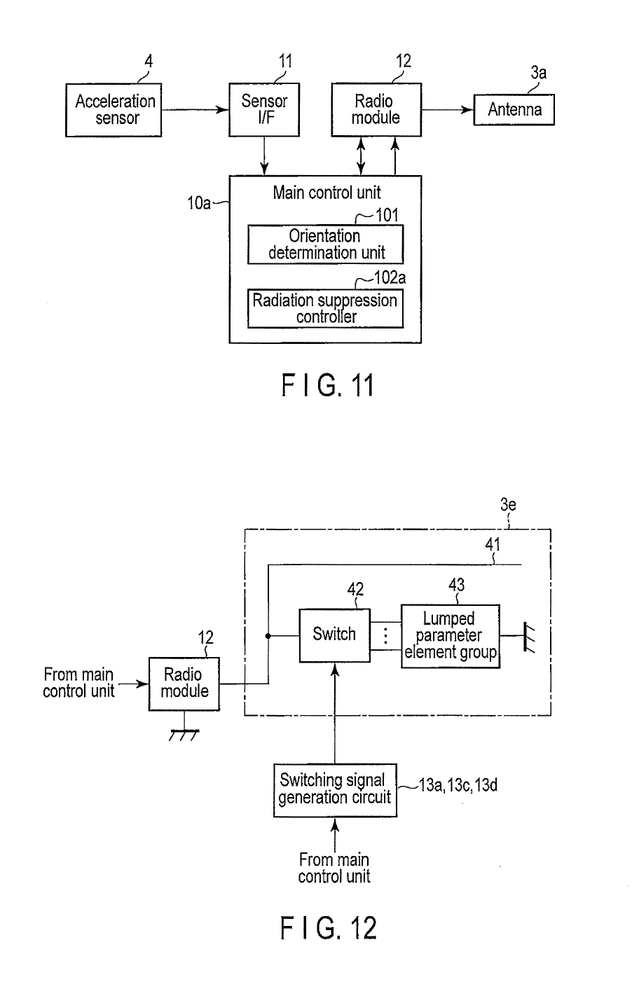

In each of the above embodiments, the antenna 3a, 3c, or 3d includes the resistor 34 or lumped parameter elements 36 to 38 used to suppress radiation, and the switch 33 or 35 provides the antenna 3a or 3c, the switching signal generation circuit 13a, 13c, or 13d generates the switching signal SS according to a switching instruction output from the main control unit 10a, 10b, 10c, or 10d, and switching control of the switch 33 or 35 in the antenna 3a, 3c, or 3d is executed based on this switching signal SS. However, the present invention is not limited to this. For example, as shown in FIG. 11, the main control unit 10a may supply a switching instruction to the radio module 12, which may suppress a radio transmission power according to this switching instruction.

### Sixth Embodiment

In each of the above embodiments, the switch 33 or 35 and the resistor or lumped parameter elements 36 to 38 are arranged on the short-circuited end side of the folded type antenna element 31. However, the present invention is not limited to this. For example, when an open-ended antenna element 41 is used, as shown in FIG. 12, a switch 42 and lumped parameter element group 43 may be arranged at the feeding end side of this antenna element 41.

### Seventh Embodiment

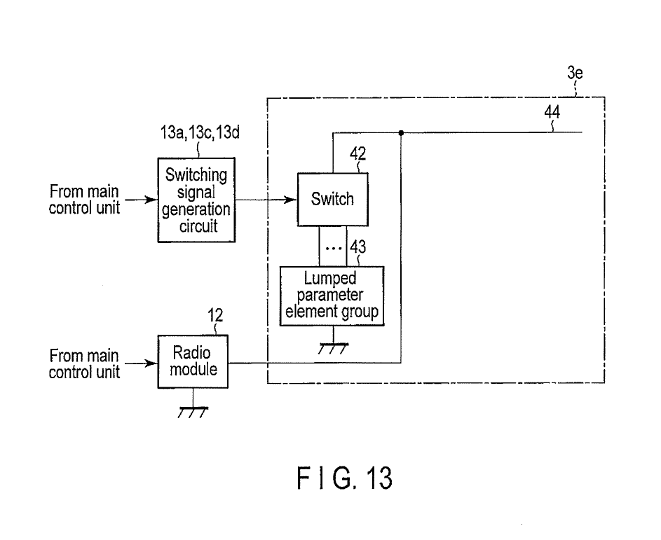

When an inverted-F antenna element 44 is used, as shown in FIG. 13, a switch 42 and lumped parameter element group 43 may be arranged at the short-circuited portion side. Note that this lumped parameter element group 43 includes at least one of a resistor, inductor, and capacitor.

### Other Embodiments

As the orientation sensor, a gyro sensor may be used in addition to the acceleration sensor. Furthermore, as the proximity sensor, an infrared sensor or optical sensor may be used in addition to the capacitance sensor. Moreover, as a selector used to select the resistor or lumped parameter element and to connect the selected element to the antenna element, other switches may be used in addition to the switch including a semiconductor switch.

In addition, when the present invention is practiced, various modifications can be made to the shape of the terminal housing, the type, arrangement, and location in the housing of the antenna, the arrangement and control sequence of a unit which suppresses a transmission power of the antenna, the types and locations in the housing of the orientation sensor and proximity sensor, the type and radio frequency bands of a wireless system, the type and arrangement of the portable information terminal, and the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A portable information terminal comprising:
a housing, on a surface portion of which a display unit is arranged;
an antenna unit arranged to extend from a side surface portion to a back surface portion of the housing;
a first sensor configured to detect an orientation of the housing; and
a controller configured to suppress a transmission power of the antenna unit when it is determined based on a detection result of the first sensor that the orientation of the housing corresponds to a horizontal state or a nearly horizontal state within a predetermined tilt angle range.

2. The terminal of claim 1, further comprising:
a second sensor configured to detect the proximity of the back surface portion of the housing with respect to a user, and wherein
the controller suppresses the transmission power of the antenna unit when it is determined based on detection results of the first sensor and the second sensor that the orientation of the housing corresponds to a horizontal state or a nearly horizontal state within a predetermined angle range and that the back surface portion of the housing comes close to the user within a pre-set distance range.

3. The terminal of claim 2, wherein the second sensor is arranged on the same surface or the same side as a surface or a side where the antenna unit is arranged of the housing, and detects the proximity of the back surface portion and a side surface portion where the antenna unit is arranged of the housing with respect to the user.

4. The terminal of claim 1, wherein the antenna unit comprises:
an antenna element, a first end portion of which is connected to a feeding point;
a resistor; and
a first selector configured to select whether a second end portion of the antenna element is connected to a ground or via the resistor, and
the controller controls the first selector to connect the second end portion of the antenna element to the ground via the resistor when the controller suppresses the transmission power of the antenna unit, and to connect the second end portion of the antenna element to the ground in other cases.

5. The terminal of claim 2, wherein the antenna unit comprises:
an antenna element, a first end portion of which is connected to a feeding point;
a resistor; and
a first selector configured to select whether a second end portion of the antenna element is connected to a ground or via the resistor, and
the controller controls the first selector to connect the second end portion of the antenna element to the ground via the resistor when the controller suppresses the transmission power of the antenna unit, and to connect the second end portion of the antenna element to the ground in other cases.

6. The terminal of claim 1, wherein the antenna unit comprises:
an antenna element, a first end portion of which is connected to a feeding point; and
a lumped parameter element configured to adjust matching characteristics of the antenna element, and the controller changes a value of the lumped parameter element so as to reduce the matching characteristics of the antenna element when the controller suppresses the transmission power of the antenna unit.

7. The terminal of claim 2, wherein the antenna unit comprises:
an antenna element, a first end portion of which is connected to a feeding point; and
a lumped parameter element configured to adjust matching characteristics of the antenna element, and
the controller changes a value of the lumped parameter element so as to reduce the matching characteristics of the antenna element when the controller suppresses the transmission power of the antenna unit.

8. The terminal of claim 1, wherein the antenna unit comprises:
an antenna element, a first end portion of which is connected to a feeding point; and
a lumped parameter element configured to adjust matching characteristics of the antenna element, and
the controller determines a radio channel used in transmission/reception of the antenna unit, and changes a value of the lumped parameter element so as to reduce the matching characteristics of the antenna element with respect to the radio channel, when the controller suppresses the transmission power of the antenna unit.

9. The terminal of claim 2, wherein the antenna unit comprises:
an antenna element, a first end portion of which is connected to a feeding point; and
a lumped parameter element configured to adjust matching characteristics of the antenna element, and
the controller determines a radio channel used in transmission/reception of the antenna unit, and changes a value of the lumped parameter element so as to reduce the matching characteristics of the antenna element with respect to the radio channel, when the controller suppresses the transmission power of the antenna unit.

10. The terminal of claim 1, wherein the antenna unit comprises:
an antenna element, a first end portion of which is connected to a feeding point;
a plurality of resistors having different resistances; and
a second selector configured to connect a second end portion of the antenna element to a ground via one of the plurality of resistors, and
the controller determines a radio channel used in transmission/reception of the antenna unit, and controls the second selector to select a resistor having a resistance corresponding to the determined radio channel from the plurality of resistors, and to connect the second end portion of the antenna element to the ground via the selected resistor when the controller suppresses the transmission power of the antenna unit.

11. The terminal of claim 2, wherein the antenna unit comprises:
an antenna element, a first end portion of which is connected to a feeding point;
a plurality of resistors having different resistances; and
a second selector configured to connect a second end portion of the antenna element to a ground via one of the plurality of resistors, and
the controller determines a radio channel used in transmission/reception of the antenna unit, and controls the second selector to select a resistor having a resistance corresponding to the determined radio channel from the plurality of resistors, and to connect the second end portion of the antenna element to the ground via the selected resistor when the controller suppresses the transmission power of the antenna unit.

12. The terminal of claim 1, wherein the antenna unit comprises:
an antenna element configured to be selectively connected to a plurality of radio modules using different radio frequency bands via an antenna switch; and
a lumped parameter element configured to adjust matching characteristics of the antenna element, and
the controller determines which radio module of the plurality of radio modules is connected to the antenna unit, and changes a value of the lumped parameter element so as to reduce the matching characteristics of the antenna element with respect to a radio frequency band used by the radio module based on the determination result when the controller suppresses the transmission power of the antenna unit.

13. The terminal of claim 2, wherein the antenna unit comprises:
an antenna element configured to be selectively connected to a plurality of radio modules using different radio frequency bands via an antenna switch; and
a lumped parameter element configured to adjust matching characteristics of the antenna element, and
the controller determines which radio module of the plurality of radio modules is connected to the antenna unit, and changes a value of the lumped parameter element so as to reduce the matching characteristics of the antenna element with respect to a radio frequency band used by the radio module based on the determination result when the controller suppresses the transmission power of the antenna unit.

14. The terminal of claim 2, wherein the antenna unit comprises:
an antenna element configured to be selectively connected to a plurality of radio modules using different radio frequency bands via an antenna switch;
a plurality of resistors having different resistances; and
a third selector configured to connect a second end portion of the antenna element to a ground via one of the plurality of resistors, and
the controller determines which radio module of the plurality of radio modules is connected to the antenna unit, and controls the third selector to select, from the plurality of resistors, a resistor having a resistance corresponding to a radio frequency band used by the radio module based on the determination result and to connect the second end portion of the antenna element to the ground via the selected resistor when the controller suppresses the transmission power of the antenna unit.

15. The terminal of claim 2, wherein the antenna unit comprises:
an antenna element configured to be selectively connected to a plurality of radio modules using different radio frequency bands via an antenna switch;
a plurality of resistors having different resistances; and
a third selector configured to connect a second end portion of the antenna element to a ground via one of the plurality of resistors, and
the controller determines which radio module of the plurality of radio modules is connected to the antenna unit, and controls the third selector to select, from the plurality of resistors, a resistor having a resistance corresponding to a radio frequency band used by the radio module based on the determination result and to connect the second end portion of the antenna element to the ground via the selected resistor when the controller suppresses the transmission power of the antenna unit.

16. The terminal of claim 2, wherein the antenna unit comprises a plurality of lumped parameter elements having different values, and a fourth selector configured to selectively connect the lumped parameter elements to the antenna element, and
the controller controls the fourth selector to select, from the plurality of lumped parameter elements, a lumped parameter element required to reduce matching characteristics of the antenna element, and to connect the selected lumped parameter element to the antenna element.

17. The terminal of claim 6, wherein the antenna unit comprises a plurality of lumped parameter elements having different values, and a fourth selector configured to selectively connect the lumped parameter elements to the antenna element, and
the controller controls the fourth selector to select, from the plurality of lumped parameter elements, a lumped parameter element required to reduce matching characteristics of the antenna element, and to connect the selected lumped parameter element to the antenna element.

18. The terminal of claim 7, wherein the antenna unit comprises a plurality of lumped parameter elements having different values, and a fourth selector configured to selectively connect the lumped parameter elements to the antenna element, and
the controller controls the fourth selector to select, from the plurality of lumped parameter elements, a lumped parameter element required to reduce matching characteristics of the antenna element, and to connect the selected lumped parameter element to the antenna element.

19. The terminal of claim 8, wherein the antenna unit comprises a plurality of lumped parameter elements having different values, and a fourth selector configured to selectively connect the lumped parameter elements to the antenna element, and
the controller controls the fourth selector to select, from the plurality of lumped parameter elements, a lumped parameter element required to reduce matching characteristics of the antenna element, and to connect the selected lumped parameter element to the antenna element.

20. The terminal of claim 9, wherein the antenna unit comprises a plurality of lumped parameter elements having different values, and a fourth selector configured to selectively connect the lumped parameter elements to the antenna element, and
the controller controls the fourth selector to select, from the plurality of lumped parameter elements, a lumped parameter element required to reduce matching characteristics of the antenna element, and to connect the selected lumped parameter element to the antenna element.
